(19) United States
(12) Patent Application Publication
(10) Pub. No.: US 2017/0058855 A1
(43) Pub. Date: Mar. 2, 2017

(54) CONTROL APPARATUS FOR INTERNAL COMBUSTION ENGINE

(71) Applicant: Toyota Jidosha Kabushiki Kaisha, Toyota-shi Aichi-ken (JP)

(72) Inventor: Satoshi Nakamura, Toyota-shi Aichi-ken (JP)

(21) Appl. No.: 15/238,013

(22) Filed: Aug. 16, 2016

(30) Foreign Application Priority Data
Aug. 25, 2015 (JP) 2015-166023

(51) Int. Cl. F02P 9/00

(52) U.S. Cl. CPC F02P 9/002

(57) ABSTRACT

A control apparatus for an internal combustion engine includes an ignition device and an electronic control unit. The ignition device includes an ignition plug that is provided in a combustion chamber of the internal combustion engine, and an ignition coil that is connected to the ignition plug. The electronic control unit is configured to: (i) acquire a temperature of the ignition device, and ii) make a discharge time of the ignition plug longer when the acquired temperature is low than when the acquired temperature is high.

### CROSS-REFERENCE TO RELATED APPLICATIONS

This application claims priority to Japanese Patent Application No. 2015-166023 filed on Aug. 25, 2015, the entire contents of which are hereby incorporated by reference.

### BACKGROUND

1. Technical Field

The present disclosure relates to a control apparatus for an internal combustion engine that controls a controlled variable of the internal combustion engine by operating an ignition device that includes an ignition plug that is provided in a combustion chamber of the internal combustion engine and an ignition coil that is connected to the ignition plug.

2. Description of Related Art

For example, in Japanese Patent Application Publication No. 2002-48038 (JP 2002-48038 A), there is described an apparatus that makes a period in which a discharge current flows between both electrodes of an ignition plug equal to a spark discharge duration time that is set in accordance with an operating state of an internal combustion engine.

By the way, in recent years, there have been growing demands for controlling the air-fuel ratio to as lean a value as possible or increasing the ratio of the amount of EGR to the amount of an air-fuel mixture as much as possible, from the standpoint of an improvement in fuel consumption and the like. In meeting such demands, a fall in flammability of the air-fuel mixture in a combustion chamber presents a problem. It should be noted herein that the inventor has found out that the flammability can be restrained from falling by lengthening a time (a discharge time) when the discharge current flows between both the electrodes of the ignition plug as much as possible.

It should be noted, however, that the amount of heat generated by an ignition device increases when the discharge time is lengthened. Therefore, the temperature of the ignition device becomes excessively high, so there is an apprehension that a degradation in the reliability of the ignition device may be incurred. In contrast, when the discharge time is set in advance such that the reliability of the ignition device can be maintained even in the case where the temperature of the ignition device reaches its highest value in an environment of usage assumed for the ignition device, there is an apprehension that the discharge time may be excessively limited in a situation where there is actually some room from a thermal point of view.

### SUMMARY

The present disclosure has been made in view of such circumstances, and provides a control apparatus for an internal combustion engine that can lengthen the time of discharge as much as possible while restraining the reliability of an ignition device from degrading.

Thus, according to one aspect of the present disclosure, there is provided a control apparatus for an internal combustion engine that includes an ignition device and an electronic control unit. The ignition device includes an ignition plug that is provided in a combustion chamber of the internal combustion engine, and an ignition coil that is connected to the ignition plug. The electronic control unit is configured to: (i) acquire a temperature of the ignition device, and (ii) make a discharge time of the ignition plug longer when the temperature acquired by the electronic control unit is low than when the temperature is high.

The temperature of the ignition device tends to rise as the discharge time of the ignition plug lengthens. Accordingly, the upper limit of the discharge time when there is no apprehension that a degradation in reliability may be incurred is considered to be longer when the temperature of the ignition device is low than when the temperature of the ignition device is high. Focusing on this point, in the configuration of the control apparatus for the internal combustion engine as described above, the electronic control unit makes the discharge time longer when the temperature of the ignition device is low than when the temperature of the ignition device is high. Thus, the discharge time can be lengthened as much as possible while restraining the reliability of the ignition device from degrading.

Besides, in the control apparatus for the internal combustion engine, the electronic control unit may be configured to: (i) acquire a gradient of a current flowing through the ignition coil, as the temperature, and (ii) execute a process of making the discharge time of the ignition plug longer when the gradient is large than when the gradient is small, as a process of making the discharge time of the ignition plug longer when the temperature acquired by the electronic control unit is low than when the temperature is high.

As the temperature of the ignition coil rises, the resistance value of the ignition coil increases, and hence the speed of rise in current at the time of application of a voltage to the ignition coil in the case where the applied voltage is given falls. Focusing on this point, in the configuration of the control apparatus for the internal combustion engine as described above, the gradient of the current can be acquired as temperature information.

Besides, in the control apparatus for the internal combustion engine, the electronic control unit may be configured to: (i) acquire a voltage applied to the ignition coil in addition to the gradient of the current flowing through the ignition coil, (ii) make the discharge time of the ignition plug longer when the gradient is large than when the gradient is small, when an applied voltage remains unchanged, and (iii) shorten the discharge time of the ignition plug as the applied voltage rises, when the gradient remains unchanged.

Even when the temperature of the ignition coil remains unchanged, the speed of rise in current at the time of application of a voltage to the ignition coil rises as the magnitude of the voltage increases. In view of this point, in the configuration of the control apparatus for the internal combustion engine as described above, the voltage applied to the ignition coil is acquired as temperature information in addition to the gradient of the current. Thus, the temperature of the ignition coil can be more accurately grasped, and hence the discharge time can be made as long as possible.

Besides, in the control apparatus for the internal combustion engine, the internal combustion engine may be a multi-cylinder internal combustion engine. The electronic control unit may be configured to: (i) acquire gradients of currents flowing through ignition coils corresponding to ignition plugs of respective cylinders, as the temperature, and (ii) set the discharge time in accordance with a smallest one of acquired gradients in the respective cylinders.

The ignition coil with the smallest gradient of the current is at the highest temperature among all the cylinders. Therefore, the ignition coil with the smallest gradient can incur a degradation in reliability due to the occurrence of discharge for the discharge time that is set based on the gradients of the currents through the other ignition coils.

By the way, it is effective to lengthen the discharge time in enhancing the flammability of the air-fuel mixture. However, it is usually effective to control the controlled variables, for example, the exhaust gas properties, the torque and the like as the averages of all the cylinders, in simplifying the control. It should be noted, however, that the making of the discharge time of each of the other ignition coils longer than the discharge time of the ignition coil with the aforementioned smallest gradient can lead to an excessive improvement of the flammability in the cylinders corresponding to the other ignition coils for the control of the averages, in controlling the aforementioned averages. Moreover, this leads to an unnecessary increase in the amount of electric power consumption for the control of the averages.

Thus, in the configuration of the control apparatus for the internal combustion engine as described above, the discharge time is set in accordance with the smallest one of the gradients. Therefore, there is a merit in that the amount of electric power consumption can be decreased as much as possible especially in controlling the aforementioned averages.

Besides, in the control apparatus for the internal combustion engine, the electronic control unit may be configured to make an air-fuel ratio of an air-fuel mixture in the combustion chamber larger when the discharge time is set long than when the discharge time is set short.

When the air-fuel ratio is raised, the amount of fuel consumption can be decreased while satisfying the torque required of the internal combustion engine. It should be noted, however, that a fall in flammability of the air-fuel mixture in the combustion chamber is incurred when the air-fuel ratio is raised. Thus, in the configuration of the control apparatus for the internal combustion engine as described above, the air-fuel ratio is raised when the discharge time is set long and the flammability of the air-fuel mixture in the combustion chamber can be restrained from falling. As a result, the amount of fuel consumption can be favorably decreased.

Besides, in the control apparatus for the internal combustion engine, the electronic control unit may be configured to: (i) determine whether or not a flammability of the air-fuel mixture in the combustion chamber is equal to or lower than a predetermined value, and (ii) gradually raise the air-fuel ratio when the electronic control unit does not determine that the flammability is equal to or lower than the predetermined value.

According to the control apparatus for the internal combustion engine as described above, the aforementioned electronic control unit makes the discharge time long when the acquired temperature is low. In the case where the discharge time is long, even when the air-fuel ratio in the combustion chamber assumes a large value, the flammability can be restrained from falling. Accordingly, when the discharge time becomes long, the air-fuel ratio is gradually raised. Therefore, the air-fuel ratio in the combustion chamber of the internal combustion engine can be raised more when the discharge time is set long than when the discharge time is set short.

Besides, in the control apparatus for the internal combustion engine, the internal combustion engine may include a recirculation passage and a recirculation valve. The recirculation passage may be configured to cause exhaust gas discharged to an exhaust passage to flow into an intake passage. The recirculation valve may be configured to adjust a flow cross-sectional area of the recirculation passage. The electronic control unit may be configured to make a ratio of an amount of exhaust gas flowing into the combustion chamber via the recirculation passage to an amount of an air-fuel mixture in the combustion chamber larger when the discharge time is set long than when the discharge time is set short.

When the aforementioned ratio is increased, the amount of fuel consumption can be decreased while satisfying the torque required of the internal combustion engine. It should be noted, however, that a fall in flammability of the air-fuel mixture in the combustion chamber is incurred when the aforementioned ratio is increased. Thus, in the configuration of the control apparatus for the internal combustion engine as described above, the aforementioned ratio is increased when the discharge time is set long and the flammability of the air-fuel mixture in the combustion chamber can be restrained from falling. As a result, the amount of fuel consumption can be favorably decreased.

Besides, in the control apparatus for the internal combustion engine, the electronic control unit may be configured to: (i) determine whether or not a flammability of the air-fuel mixture in the combustion chamber of the internal combustion engine is equal to or lower than a predetermined value, and (ii) gradually increase the ratio when the electronic control unite does not determine that the flammability is equal to or lower than the predetermined value.

According to the control apparatus for the internal combustion engine as described above, the electronic control unit makes the discharge time long when the acquired temperature is low. In the case where the discharge time is long, even when the ratio of the amount of exhaust gas flowing into the combustion chamber via the recirculation passage and the intake passage to the amount of the air-fuel mixture in the combustion chamber assumes a large value, the flammability can be restrained from falling. Accordingly, when the discharge time lengthens, the aforementioned ratio is gradually increased. Therefore, the aforementioned ratio can be increased more when the discharge time is set long than when the discharge time is set short.

In the control apparatus for the internal combustion engine, the ignition device may include an ignition switching element and a control switching element. The ignition switching element may be configured to open-close a first loop circuit that includes a primary-side coil of the ignition coil and a first electric power supply. The control switching element may be configured to open-close a second loop circuit that includes a second electric power supply and the primary-side coil. The electronic control unit may be configured to: (i) cause the ignition plug to discharge through an electromotive force that is generated in a secondary-side coil of the ignition coil by changing over the ignition switching element from a closed state to an open state, (ii) after discharging the ignition plug, control a discharge current of the ignition plug by performing an operation of opening-closing the control switching element, and (iii) set the discharge time by setting a timing for finishing control of the discharge current of the ignition plug. It should be noted herein that: a polarity of a first voltage and a polarity of a second voltage are opposite to each other, the first voltage is applied to the primary-side coil by the first electric power supply at a time when the first loop circuit is a closed loop, and the second voltage is applied to the primary-side coil by the second electric power supply at a time when the second loop circuit is a closed loop.

In the aforementioned configuration, a voltage that is opposite in polarity to the voltage applied to the primary-side coil at the time when the first loop circuit is a closed loop is applied to the primary-side coil through the operation of closing the control switching element. Then, when the absolute value of the current flowing through the primary-side coil is increased, the discharge current of the ignition plug can be controlled in accordance with the speed of increase in the absolute value, through the operation of opening-closing the control switching element.

Moreover, in the configuration of the control apparatus for the internal combustion engine as described above, the discharge time can be set by setting the timing for ending the control of the discharge current by the electronic control unit.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a configuration view of a system that is equipped with a control apparatus for an internal combustion engine according to the first embodiment of the present disclosure;

FIG. 2 is a circuit diagram showing a circuit configuration of an ignition control system according to the first embodiment of the present disclosure;

FIG. 3A, is a time chart exemplifying ignition control according to the first embodiment of the present disclosure;

FIG. 3B, is a time chart exemplifying ignition control according to the first embodiment of the present disclosure;

FIG. 3C, is a time chart exemplifying ignition control according to the first embodiment of the present disclosure;

FIG. 3D, is a time chart exemplifying ignition control according to the first embodiment of the present disclosure;

FIG. 3E, is a time chart exemplifying ignition control according to the first embodiment of the present disclosure;

FIG. 3F, is a time chart exemplifying ignition control according to the first embodiment of the present disclosure;

FIG. 3G, is a time chart exemplifying ignition control according to the first embodiment of the present disclosure;

FIG. 4A, is a circuit diagram exemplifying ignition control according to the first embodiment of the present disclosure;

FIG. 4B, is a circuit diagram exemplifying ignition control according to the first embodiment of the present disclosure;

FIG. 4C, is a circuit diagram exemplifying ignition control according to the first embodiment of the present disclosure;

FIG. 4D, is a circuit diagram exemplifying ignition control according to the first embodiment of the present disclosure;

FIG. 5 is a block diagram showing part of a process of the control apparatus according to the first embodiment of the present disclosure;

FIG. 6 is a flowchart showing a processing procedure of a control signal generating process unit shown in FIG. 5 according to the first embodiment of the present disclosure;

FIG. 7 is a flowchart showing a processing procedure of a target correction amount calculating process unit shown in FIG. 5 according to the first embodiment of the present disclosure;

FIG. 8 is a flowchart showing a processing procedure of the control signal generating process unit according to the second embodiment of the present disclosure;

FIG. 9 is a block diagram showing part of a process of a control apparatus according to the third embodiment of the present disclosure;

FIG. 10 is a flowchart showing a processing procedure of a control signal generating process unit shown in FIG. 9 according to the third embodiment of the present disclosure; and

FIG. 11 is a flowchart showing a processing procedure of an EGR correction amount calculating process unit shown in FIG. 9 according to the third embodiment of the present disclosure.

### DETAILED DESCRIPTION OF EMBODIMENTS

First of all, a control apparatus for an internal combustion engine according to the first embodiment will be described hereinafter with reference to the drawings.

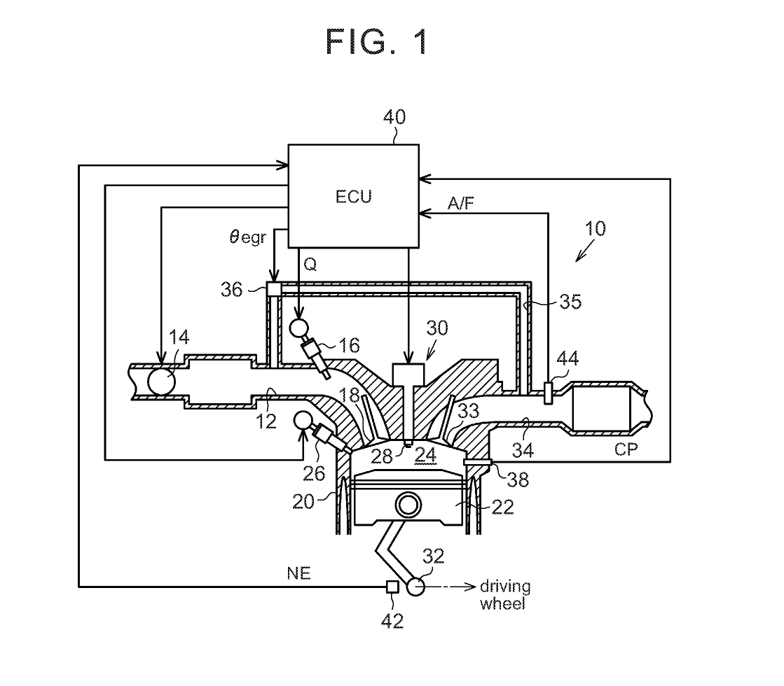

An internal combustion engine 10 shown in FIG. 1 is a spark ignition-type multi-cylinder internal combustion engine. An intake passage 12 of the internal combustion engine 10 is provided with an electronically controlled throttle valve 14 for making the flow cross-sectional area of the intake passage 12 variable. A port injection valve 16 that injects fuel into an intake port is provided in the intake passage 12 downstream of the throttle valve 14. As an intake valve 18 operates to be opened, a combustion chamber 24 that is defined by a cylinder 20 and a piston 22 is filled with the air in the intake passage 12 and the fuel injected from the port injection valve 16. An injection port of an in-cylinder injection valve 26 faces the combustion chamber 24. Fuel can be directly injected and supplied to the combustion chamber 24 by the in-cylinder injection valve 26. An ignition plug 28 of an ignition device 30 protrudes into the combustion chamber 24. Moreover, a mixture of air and fuel is flamed through spark ignition by the ignition plug 28. This air-fuel mixture is then burned. Part of combustion energy of the air-fuel mixture is converted into rotational energy of a crankshaft 32 via the piston 22. Driving wheels of a vehicle can be mechanically coupled to the crankshaft 32. Incidentally, in the present embodiment, the vehicle is assumed to have the internal combustion engine 10 as the only component that applies motive power to the driving wheels.

The burnt air-fuel mixture is discharged to an exhaust passage 34 as exhaust gas, as an exhaust valve 33 operates to be opened. The exhaust passage 34 is connected to the intake passage 12 via a recirculation passage 35. Moreover, the recirculation passage 35 is provided with a recirculation valve 36 that adjusts the flow cross-sectional area thereof.

An ECU 40 is a control apparatus that is designed to control the internal combustion engine 10. The ECU 40 captures output values of various types of sensors such as a crank angle sensor 42 that detects a rotational speed NE of the crankshaft 32, an air-fuel ratio sensor 44 that detects an air-fuel ratio A/F in the combustion chamber 24 based on components of exhaust gas, an in-cylinder pressure sensor 38 that detects a pressure in the combustion chamber 24 (an in-cylinder pressure CP), and the like. Then, the ECU 40 controls controlled variables (exhaust gas properties, torque and the like) of the internal combustion engine 10 by operating various actuators such as the throttle valve 14, the port injection valve 16, the in-cylinder injection valve 26, the ignition device 30 and the like, based on the captured output values.

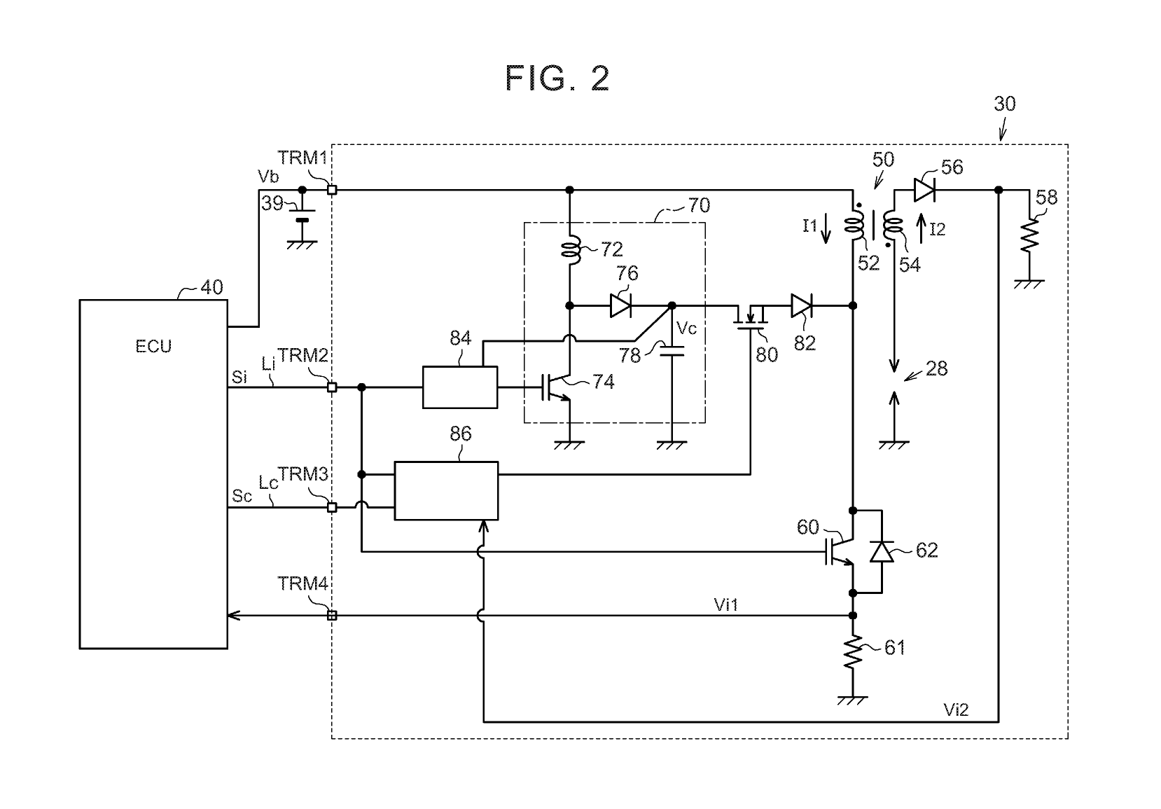

FIG. 2 shows a circuit configuration of the ignition device 30. As shown in FIG. 2, the ignition device 30 is equipped with an ignition coil 50 having a primary-side coil 52 and a secondary-side coil 54, which are magnetically coupled to each other. Incidentally, in FIG. 2, a black circle allocated to one of a pair of terminals of each of the primary-side coil 52 and the secondary-side coil 54 indicates a terminal at which the polarity of an electromotive force generated in the primary-side coil 52 and the polarity of an electromotive force generated in the secondary-side coil 54 are equal to each other when the magnetic flux interlinking the primary-side coil 52 and the secondary-side coil 54 is changed with both ends of the primary-side coil 52 and the secondary-side coil 54 open.

The ignition plug 28 is connected to one of the terminals of the secondary-side coil 54. The other terminal of the secondary-side coil 54 is grounded via a diode 56 and a shunt resistor 58. The diode 56 is a rectifier element that allows a current to flow from the ignition plug 28 to the ground via the secondary-side coil 54 and that keeps the current from flowing in the opposite direction. The shunt resistor 58 is a resistor for detecting a current flowing through the secondary-side coil 54 through a voltage drop Vi2 in the shunt resistor 58. In other words, the shunt resistor 58 is a resistor for detecting a discharge current of the ignition plug 28.

A positive electrode of an external battery 39 is connected to one of the terminals of the primary-side coil 52 of the ignition coil 50 via a terminal TRM1 of the ignition device 30. Besides, the other terminal of the primary-side coil 52 is grounded via an ignition switching element 60 and a shunt resistor 61. Incidentally, in the present embodiment, the ignition switching element 60 is an insulated gate bipolar transistor (an IGBT). Besides, a diode 62 is connected in an inverse-parallel manner to the ignition switching element 60.

An electric power captured from the terminal TRM1 is also captured by a step-up circuit 70. In the present embodiment, the step-up circuit 70 is configured as a step-up chopper circuit. That is, the step-up circuit 70 is equipped with an inductor 72 that is connected at one end thereof to the terminal TRM1 side, and the other end of the inductor 72 is grounded via a step-up switching element 74. Incidentally, in the present embodiment, the step-up switching element 74 is an IGBT. A diode 76 is connected on an anode side thereof to a point between the inductor 72 and the step-up switching element 74. The diode 76 is grounded on a cathode side thereof via a capacitor 78. A charge voltage Vc of the capacitor 78 is an output voltage of the step-up circuit 70.

A point between the diode 76 and the capacitor 78 is connected to a point between the primary-side coil 52 and the ignition switching element 60 via a control switching element 80 and a diode 82. In other words, an output terminal of the step-up circuit 70 is connected to a point between the primary-side coil 52 and the ignition switching element 60 via the control switching element 80 and the diode 82. In the present embodiment, the control switching element 80 is an MOS electric field effect transistor. The aforementioned diode 82 is a rectifier element for keeping a current from flowing backward from the primary-side coil 52 side and the ignition switching element 60 side to the step-up circuit 70 side via a parasitic diode of the control switching element 80.

A step-up control unit 84 is a drive circuit that controls the output voltage of the step-up circuit 70 by performing an operation of opening-closing the step-up switching element 74 based on an ignition signal Si input to a terminal TRM2. Incidentally, the step-up control unit 84 monitors the output voltage of the step-up circuit 70 (the charge voltage Vc of the capacitor 78), and stops the operation of opening-closing the step-up switching element 74 when the output voltage is equal to or higher than a predetermined value.

A discharge control unit 86 is a drive circuit that controls the discharge current of the ignition plug 28 by performing an operation of opening-closing the control switching element 80 based on an ignition signal Si input to the terminal TRM2, and a discharge waveform control signal Sc input to a terminal TRM3.

The terminal TRM2 of the ignition device 30 is connected to the ECU 40 via an ignition communication line Li, and the terminal TRM3 is connected to the ECU 40 via a waveform control communication line Lc. In a first mode in which the air-fuel ratio of the internal combustion engine 10 is controlled to a first target value (a theoretical air-fuel ratio in this case), the ECU 40 outputs the ignition signal Si via the ignition communication line Li, and does not output the discharge waveform control signal Sc to the waveform control communication line Lc. Besides, in a second mode in which the air-fuel ratio of the internal combustion engine 10 is controlled to a predetermined air-fuel ratio that is leaner than the first target value, the ECU 40 outputs the ignition signal Si via the ignition communication line Li, and outputs the discharge waveform control signal Sc via the waveform control communication line Lc. It should be noted herein that both the ignition signal Si and the discharge waveform control signal Sc are pulse signals of a logic H in the present embodiment.

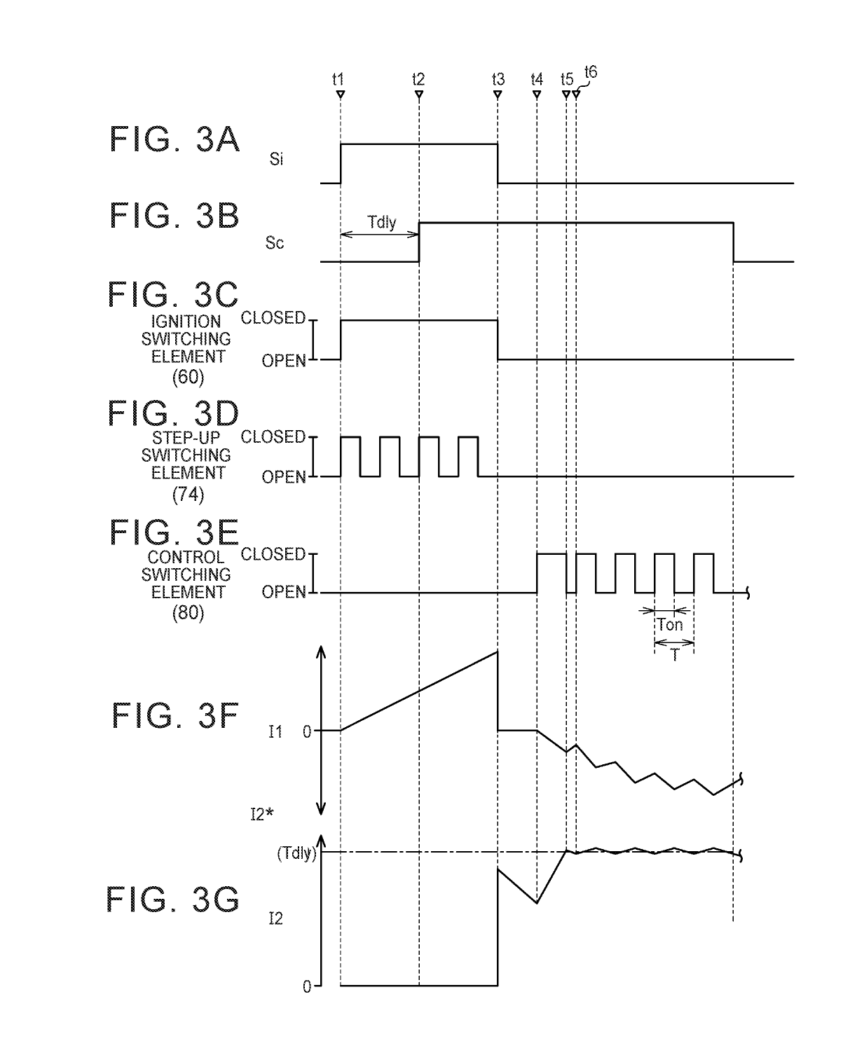

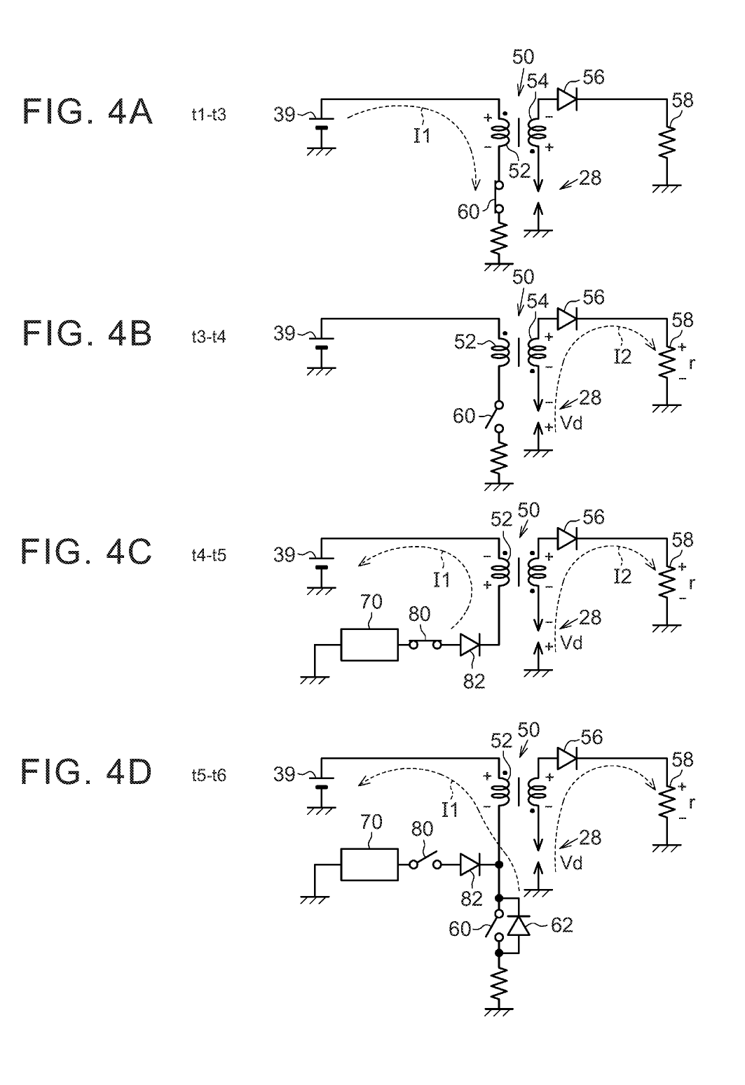

Next, ignition control according to the present embodiment, especially the control in the second mode will be exemplified using FIGS. 3A to 3G and FIGS. 4A to 4D. FIG. 3A shows how the ignition signal Si shifts. FIG. 3B shows how the discharge waveform control signal Se shifts. FIG. 3C shows how the state of the operation of opening-closing the ignition switching element 60 shifts. FIG. 3D shows how the state of the operation of opening-closing the step-up switching element 74 shifts. Besides, FIG. 3E shows how the state of the operation of opening-closing the control switching element 80 shifts. FIG. 3F shows how the current I1 flowing through the primary-side coil 52 shifts. FIG. 3G shows how the current I2 flowing through the secondary-side coil 54 shifts. Incidentally, the signs of the currents I1 and I2 are defined to be positive when they flow as indicated by arrows shown in FIG. 2.

When the ignition signal Si is input to the ignition device 30 at a time point t1, the ignition device 30 performs an operation of turning on (closing) the ignition switching element 60. Thus, the current I1 flowing through the primary-side coil 52 gradually increases. FIG. 4A shows a route of the current flowing through the primary-side coil 52 in this case. As shown in FIG. 4A, when the operation of closing the ignition switching element 60 is performed, a first loop circuit, which is a loop circuit that is equipped with the battery 39, the primary-side coil 52 and the ignition switching element 60, becomes a closed-loop circuit, and a current flows therethrough. Incidentally, the interlinkage magnetic flux of the secondary-side coil 54 gradually increases due to a gradual increase in the current flowing through the primary-side coil 52, so an electromotive force that counterbalances the increase in the interlinkage magnetic flux is generated in the secondary-side coil 54. However, this electromagnetic force makes the anode side of the diode 56 negative, so no current flows through the secondary-side coil 54.

Besides, as shown in FIGS. 3A to 3G, when the ignition signal Si is input to the ignition device 30, the step-up control unit 84 performs the operation of opening-closing the step-up switching element 74. After that, at a time point t2 after the lapse of a delay time Tdly from the time point t1 when the ignition signal Si is input to the ignition device 30, the discharge waveform control signal Sc is input to the ignition device 30.

After that, when the ignition signal Si is stopped from being input at a time point t3, in other words, when the voltage of the ignition communication line Li is changed from a voltage of the logic H to a voltage of a logic L, the ignition device 30 performs an operation of opening the ignition switching element 60. Thus, the current I1 flowing through the primary-side coil 52 becomes equal to zero, and a current flows through the secondary-side coil 54 due to a back electromotive force that is generated in the secondary-side coil 54. Thus, the ignition plug 28 starts discharging.

FIG. 4B shows a route of the current in this case. As shown in the drawing, when the interlinkage magnetic flux in the secondary-side coil 54 is about to decrease due to the shutoff of the current in the primary-side coil 52, a back electromotive force that is applied in such a direction as to counterbalance the decrease in the interlinkage magnetic flux is generated in the secondary-side coil 54. Thus, a current I2 flows through the ignition plug 28, the secondary-side coil 54, the diode 56 and the shunt resistor 58. When the current I2 flows through the secondary-side coil 54, a voltage drop Vd occurs in the ignition plug 28, and a voltage drop “r×I2” corresponding to a resistance value r of the shunt resistor 58 occurs therein. Thus, if a voltage drop in a forward direction of the diode 56 and the like are ignored, a voltage “Vd+r×I2”, which is the sum of the voltage drop Vd in the ignition plug 28 and the voltage drop in the shunt resistor 58, is applied to the secondary-side coil 54. This voltage gradually decreases the interlinkage magnetic flux of the secondary-side coil 54. A gradual decrease in the current I2 flowing through the secondary-side coil 54 from the time point t3 to a time point t4 in FIG. 3G is a phenomenon resulting from the application of the voltage “Vd+r×I2” to the secondary-side coil 54.

As shown in FIGS. 3A to 3G, at and after the time point t4, the discharge control unit 86 performs an operation of opening-closing the control switching element 80. FIG. 4C shows a route of the current in a period from the time point t4 and a time point t5 when the control switching element 80 is closed. It should be noted herein that a second loop circuit, which is a loop circuit that is equipped with the step-up circuit 70, the control switching element 80, the diode 82, the primary-side coil 52 and the battery 39, is a closed loop, and a current flows therethrough.

FIG. 4D shows a route of the current in a period from the time point t5 to a time point t6 when the control switching element 80 is open. In this case, a back electromotive force that counterbalances changes in magnetic flux resulting from a decrease in the absolute value of the current flowing through the primary-side coil 52 is generated in the primary-side coil 52. Thus, a third loop circuit, which is a loop circuit that is equipped with the diode 62, the primary-side coil 52 and the battery 39, becomes a loop circuit, and a current flows therethrough.

It should be noted herein that if a time ratio D of a closing operation period Ton to a cycle T of the operation of opening-closing the control switching element 80 shown in FIG. 3E is manipulated, the current flowing through the primary-side coil 52 can be controlled. The discharge control unit 86 performs the control of gradually increasing the absolute value of the current I1 flowing through the primary-side coil 52, in accordance with the time ratio D. The sign of the current I1 in this period is the opposite of the sign of the current I1 that flows through the primary-side coil 52 when the ignition switching element 60 is closed. Therefore, if the magnetic flux generated by the current I1 flowing through the primary-side coil 52 is assumed to be positive when the ignition switching element 60 is closed, the current I1 generated through the opening-closing of the control switching element 80 decreases the magnetic flux. It should be noted herein that when the speed of gradual decrease in the interlinkage magnetic flux of the secondary-side coil 54 resulting from the current I1 flowing through the primary-side coil 52 coincides with the speed of gradual decrease at the time of application of the voltage “Vd+r×I2” to the secondary-side coil 54, the current flowing through the secondary-side coil 54 does not decrease. In this case, the loss of electric power caused by the ignition plug 28 and the shunt resistor 58 is compensated for by an electric power output by an electric power supply that is constituted of the step-up circuit 70 and the battery 39.

In contrast, when the speed of gradual decrease in the interlinkage magnetic flux of the secondary-side coil 54 resulting from the current I1 flowing through the primary-side coil 52 is lower than the speed of gradual decrease at the time of application of the voltage “Vd+r×I2” to the secondary-side coil 54, the current I2 flowing through the secondary-side coil 54 gradually decreases. Due to the gradual decrease in the current I2, the interlinkage magnetic flux gradually decreases at the speed of gradual decrease at the time of application of the voltage “Vd+r×I2” to the secondary-side coil 54. It should be noted, however, that the speed of gradual decrease in the current I2 flowing through the secondary-side coil 54 is lower than in the case where the absolute value of the current I1 flowing through the primary-side coil 52 does not gradually increase.

Besides, when the absolute value of the current I1 flowing through the primary-side coil 52 is gradually increased such that the actual speed of gradual decrease in the interlinkage magnetic flux becomes higher than the speed of gradual decrease in the interlinkage magnetic flux of the secondary-side coil 54 at the time of application of the voltage “Vd+r×I2” to the secondary-side coil 54, the voltage of the secondary-side coil 54 becomes high due to a back electromotive force that restrains the interlinkage magnetic flux from decreasing. Then, the current I2 flowing through the secondary-side coil 54 increases such that “Vd+r×I2” becomes equal to the voltage of the secondary-side coil 54.

Due to the foregoing, the current I2 flowing through the secondary-side coil 54 can be controlled by controlling the speed of gradual increase in the absolute value of the current I1 flowing through the primary-side coil 52. In other words, the discharge current of the ignition plug 28 can be so controlled as to either increase or decrease.

In the discharge control unit 86, the aforementioned time ratio D of the control switching element 80 is manipulated to control, in a feedback manner, a discharge current value that is determined from the voltage drop Vi2 in the shunt resistor 58, to a discharge current command value I2*.

Incidentally, the ignition communication line Li, the ignition coil 50, the ignition plug 28, the shunt resistor 58, the ignition switching element 60, the shunt resistor 61, the diode 62, the control switching element 80 and the diode 82, which are shown in FIG. 2, are provided for each of the cylinders. However, only one component corresponding to each of the cylinders is representatively shown in FIG. 2 as to each of the ignition communication line Li, the ignition coil 50, the ignition plug 28, the shunt resistor 58, the ignition switching element 60, the shunt resistor 61, the diode 62, the control switching element 80 and the diode 82. Incidentally, in the present embodiment, a single component is allocated to the plurality of the cylinders as to the waveform control communication line Lc, the step-up circuit 70, the step-up control unit 84 and the discharge control unit 86. Moreover, the discharge control unit 86 selects and operates the corresponding control switching element 80, depending on which one of the cylinders is relevant to the ignition signal Si input to the ignition device 30. Besides, the step-up control unit 84 performs step-up control as soon as the ignition signal Si of any one of the cylinders is input to the ignition device 30.

The discharge control unit 86 controls the discharge current to the discharge current command value I2* in a period from a timing corresponding to the lapse of a prescribed time from a falling edge of the ignition signal Si to a timing corresponding to a falling edge of the discharge waveform control signal Sc, unless the ignition signal Si is input. Then, as shown in FIGS. 3A to 3G, the discharge control unit 86 variably sets the discharge current command value I2* in accordance with the delay time Tdly of the timing when the discharge waveform control signal Sc is input with respect to the timing when the ignition signal Si is input to the ignition device 30. Thus, in the ECU 40, the discharge current command value I2* can be variably set by manipulating the delay time Tdly.

By the way, as the degree of leanness of the air-fuel ratio of the air-fuel mixture in the combustion chamber 24 is increased, the amount of fuel consumption can be decreased while satisfying the torque required of the internal combustion engine 10. On the other hand, when the air-fuel ratio of the air-fuel mixture becomes lean, the flammability of the air-fuel mixture falls. It should be noted, however, that this fall in flammability can be compensated for by lengthening the time (the discharge time) for controlling the discharge current to the discharge current command value I2* with the aid of the discharge control unit 86.

It should be noted that the amount of heat generated by the ignition coil 50 and the like increases when the discharge time is lengthened. Therefore, there is an upper limit resulting from heat generation in setting the discharge time. It should be noted herein that the permitted amount of heat generation depends on the current temperature of the ignition coil 50. Therefore, in the present embodiment, the discharge time is set to a longest permissible time by lengthening the discharge time as the temperature of the ignition coil 50 falls. Thus, the rate of fuel consumption is decreased by making the air-fuel ratio as lean as possible while setting the discharge time as long as possible. In other words, the utilization efficiency of fuel is enhanced.

In order to execute this process, the ECU 40 acquires the voltage drop Vi1 in the shunt resistor 61 as the current I1 flowing through the primary-side coil 52, via a terminal TRM4. Then, the ECU 40 generates the discharge waveform control signal Sc based on this acquired voltage drop Vi1. Incidentally, although only the single terminal TRM4 is depicted in FIG. 2, the number of terminals TRM4 is actually equal to the number of cylinders. The ECU 40 acquires the voltage drop Vi1 regarding each of the cylinders.

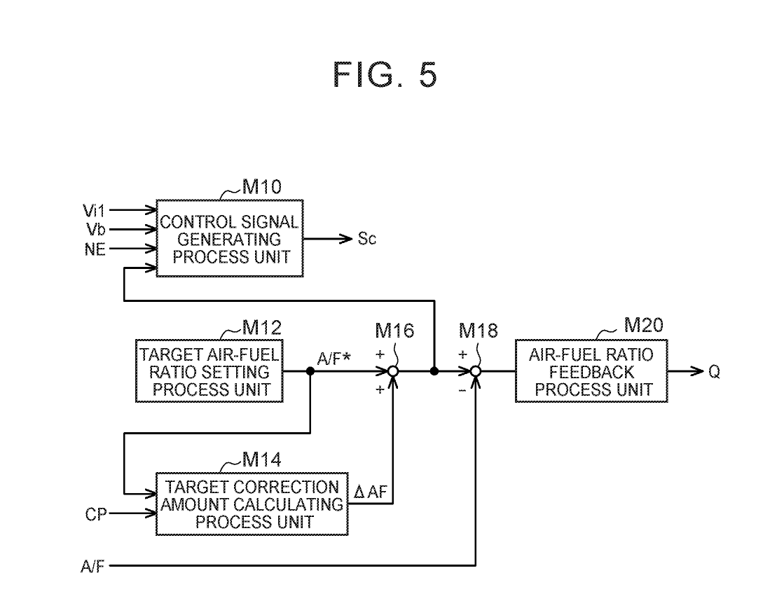

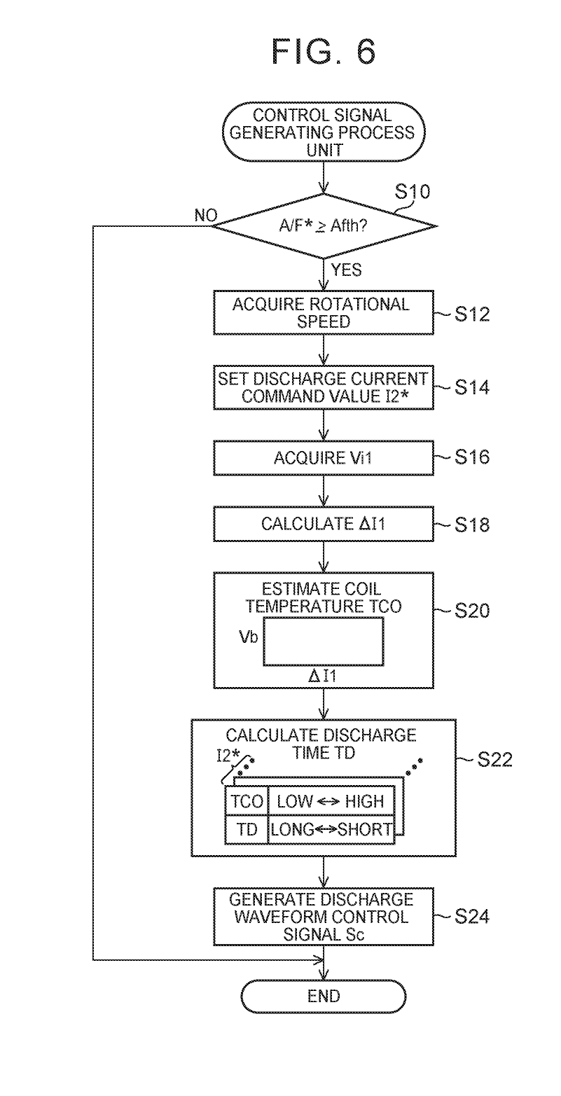

FIG. 5 shows a process of generating the discharge waveform control signal Sc and a process regarding air-fuel ratio control in particular, among the processes that are executed by the ECU 40. A control signal generating process unit M10 generates the discharge waveform control signal Sc based on the voltage drop Vi1, a terminal voltage Vb of the battery 39, the rotational speed NE and a target value A/F* of the air-fuel ratio. FIG. 6 shows a processing procedure of the control signal generating process unit M10. This process is repeatedly executed, for example, on a predetermined cycle. Incidentally, this process is independently executed for each of the cylinders. Every time an ignition timing of a relevant one of the cylinders arrives, the discharge waveform control signal Sc to be output to the waveform control communication line Lc that is common to all the cylinders is generated. However, the process is common to the respective cylinders.

In this series of processing steps, the control signal generating process unit M10 first determines whether or not the target value A/F* of the air-fuel ratio is equal to or larger than a predetermined value Afth (S10). This processing is designed to determine whether or not the flammability of the air-fuel mixture in the combustion chamber 24 is equal to or lower than a predetermined flammability when the discharge control unit 86 does not perform the control of the discharge current. That is, the control signal generating process unit M10 determines whether or not the flammability is equal to or lower than the predetermined flammability when the ignition plug 28 is caused to discharge until the discharge current naturally becomes equal to zero after the start of discharge by the ignition plug 28, by holding the ignition switching element 60 closed for a predetermined period and then opening this ignition switching element 60. It should be noted that the flammability is assumed to rise as the flaming delay as the time required from the timing of discharge by the ignition plug 28 (the ignition timing) to the timing of flaming of the air-fuel mixture in the combustion chamber 24 decreases, in the present embodiment. Incidentally, in the present embodiment, the air-fuel mixture is assumed to have such a property that the timing for flaming the air-fuel mixture is difficult to control to a desired timing by advancing the ignition timing when the aforementioned flammability is equal to or lower than the predetermined flammability. That is, the following case is assumed. When the ignition timing is advanced, the flaming delay increases due to a fall in the temperature of the air-fuel mixture at the ignition timing. Thus, it becomes difficult to use the ignition timing as a manipulated variable in compensating for the flaming delay.

Then, if it is determined that the target value A/F* of the air-fuel ratio is equal to or larger than the predetermined value Afth (YES in S10), the control signal generating process unit M10 acquires the rotational speed NE on the assumption that the second mode in which the discharge control unit 86 performs the control of the discharge current is established (S12). Then, the control signal generating process unit M10 sets the discharge current command value I2* based on the rotational speed NE (S14). The control signal generating process unit M10 sets the discharge current command value I2* to a value that increases as the rotational speed NE rises. This is a setting based on the fact that a blow break is likely to occur due to the stretch of the discharge current between both electrodes of the ignition plug 28 because the amount of air current in the combustion chamber 24 increases as the rotational speed NE rises.

Subsequently, the control signal generating process unit M10 acquires a plurality of sampling values of the voltage drop Vi1 at the time when the ignition switching element 60 is closed (S16). It should be noted herein that the plurality of the sampling values constitute time-series data on voltage drops Vi1 that are temporally successive to one another. Then, the control signal generating process unit M10 calculates a gradient ΔI1 of the current flowing through the ignition coil 50 based on computation of differences among the plurality of the acquired voltage drops Vi1 (S18).

Then, the control signal generating process unit M10 calculates (estimates) a temperature of the ignition coil 50 (a coil temperature TCO) based on the gradient ΔI1 and the terminal voltage Vb of the battery 39 (S20). In this case, the control signal generating process unit M10 calculates the coil temperature TCO using a map that determines how the gradient ΔI1 and the terminal voltage Vb of the battery 39 are related to the coil temperature TCO. It should be noted herein that when the terminal voltage Vb of the battery 39 is constant, the coil temperature TCO is calculated as a value that falls as the gradient ΔI1 increases. This is because the rising speed of the current flowing through the ignition coil 50 (the current I1 flowing through the primary-side coil 52) rises even when the voltage applied to the ignition coil 50 remains the same, on the ground that the resistance value of the ignition coil 50 decreases as the coil temperature TCO falls. Besides, if the gradient ΔI1 remains unchanged, the coil temperature TCO is set to a value that rises as the terminal voltage Vb of the battery 39 rises. This is because the coil temperature TCO rises as the terminal voltage Vb rises when the gradient ΔI1 remains unchanged, on the ground that the gradient ΔI1 increases as the terminal voltage Vb rises when the terminal voltage Vb of the battery 39 is applied to the primary-side coil 52 through the process shown in FIG. 4A.

Subsequently, the control signal generating process unit M10 sets a discharge time TD that determines a period of the control of the discharge current to the discharge current command value I2* by the discharge control unit 86 (S22). In this case, the control signal generating process unit M10 sets the discharge time TD using a map that determines how the coil temperature TCO and the discharge current command value I2* are related to the discharge time TD. In concrete terms, the control signal generating process unit M10 sets the discharge time TD to a longer value when the coil temperature TCO is low than when the coil temperature TCO is high. In concrete terms, the control signal generating process unit M10 continuously increases the discharge time TD as the coil temperature TCO falls. It should be noted herein that the map constitutes data that determine a value of an output variable (the discharge time TD in this case) for discrete values of input variables (the coil temperature TCO and the discharge current command value I2* in this case). Therefore, the control signal generating process unit M10 continuously increases the discharge time TD as the coil temperature TCO falls, through the use of interpolation computation.

The control signal generating process unit M10 sets the discharge time TD to a value that shortens as the discharge current command value I2* increases. This is a setting resulting from the discharge energy being made equal to a largest permissible value. That is, even when the discharge time TD remains unchanged, the amount of discharge energy increases as the discharge current command value I2* increases. Therefore, the longest permissible length of the discharge time TD shortens as the discharge current command value I2* increases.

If the processing of step S22 is completed, the control signal generating process unit M10 generates the discharge waveform control signal Sc based on the discharge current command value I2* and the discharge time TD (S24). Incidentally, if the processing of step S24 is completed or if the result of the determination in step S10 is negative, the control signal generating process unit M10 temporarily ends this series of processing steps.

Returning to FIG. 5, a target air-fuel ratio setting process unit M12 makes a changeover between the first mode in which the target value A/F* is set to a first target value (the theoretical air-fuel ratio) and a second mode in which the target value A/F* is set to a predetermined air-fuel ratio that is leaner than the theoretical air-fuel ratio. Incidentally, the predetermined value Afth in the processing of step S10 in FIG. 6 is set to an air-fuel ratio in the second mode (a base value in the second mode) that is set by the target air-fuel ratio setting process unit M12. Incidentally, in the present embodiment, the base value in the second mode is set to a value that can ensure flammability even by the discharge time TD that is set in the processing of step S22 in FIG. 6 when the temperature of the ignition coil 50 is equal to a highest assumable value.

In the second mode, a target correction amount calculating process unit M14 calculates and outputs a correction amount ΔAF for correcting the target value A/F*, based on the in-cylinder pressure CP detected by the in-cylinder pressure sensor 38. A correction process unit M16 corrects the target value A/F* by adding the correction amount ΔAF to the target value A/F* set by the target air-fuel ratio setting process unit M12.

A deviation calculating process unit M18 outputs a value obtained by subtracting the air-fuel ratio A/F detected by the air-fuel ratio sensor 44 from the target value A/F* output from the correction process unit M16. An air-fuel ratio feedback process unit M20 manipulates an amount of fuel injected from the port injection valve 16 and the in-cylinder injection valve 26 to control the air-fuel ratio A/F to the target value A/F* in a feedback manner, based on the value output by the deviation calculating process unit M18.

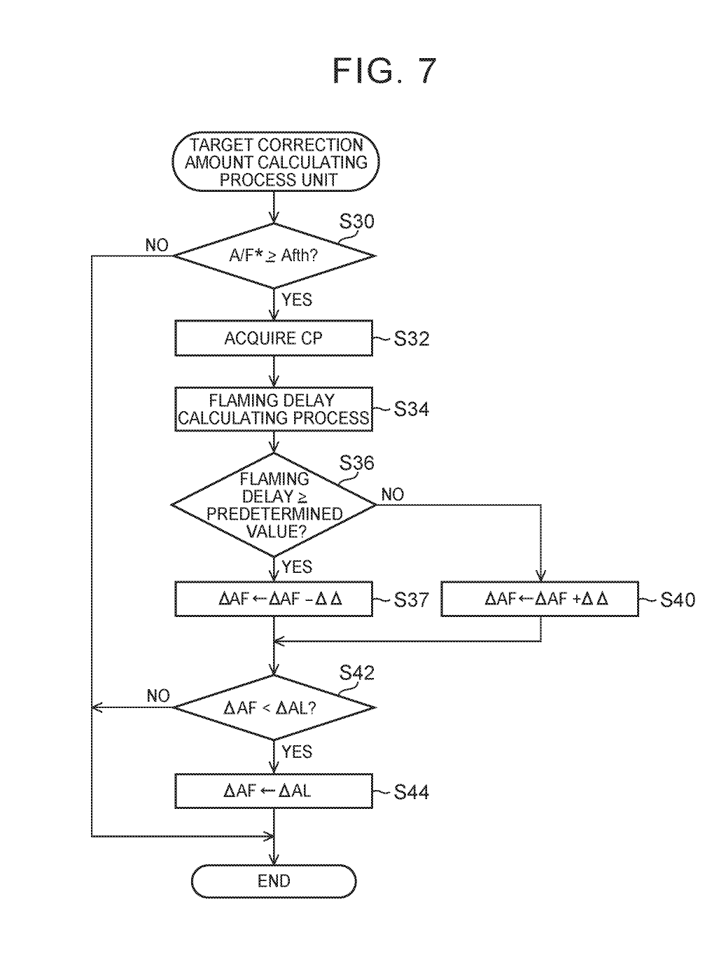

FIG. 7 shows a processing procedure of the target correction amount calculating process unit M14. This process is repeatedly executed, for example, on a predetermined cycle. In this series of processing steps, the target correction amount calculating process unit M14 first determines whether or not the target value A/F* of the air-fuel ratio is equal to or larger than the predetermined value Afth (S30). This processing is designed to determine whether or not the second mode is established. Then, if it is determined that the target value A/F* of the air-fuel ratio is equal to or larger than the predetermined value Afth (YES in S30), the target correction amount calculating process unit M14 acquires time-series data on the in-cylinder pressure CP detected by the in-cylinder pressure sensor 38 (S32). Subsequently, the target correction amount calculating process unit M14 calculates a flaming delay based on the time-series data on the in-cylinder pressure CP (S34). This processing can be realized by detecting the timing of flaming, for example, by calculating a change in the pressure in the combustion chamber 24 except a change in pressure resulting from a change in the volume of the combustion chamber 24, based on the time-series data on the in-cylinder pressure CP. Incidentally, the flaming delay thus calculated is a flaming delay in each of the in-cylinder pressure sensors 38 that are provided in the respective cylinders. This can be realized by executing, for example, the process shown in FIG. 7 on an ignition cycle of each of the cylinders.

Then, the target correction amount calculating process unit M14 determines whether or not the flaming delay is equal to or larger than a predetermined value (S36). This processing is designed to determine whether or not the flammability of the air-fuel mixture in the combustion chamber 24 is equal to or lower than a predetermined flammability. Then, if it is determined that the flaming delay is equal to or higher than the predetermined value (YES in S36), the target correction amount calculating process unit M14 subtracts a predetermined amount ΔΔ from the correction amount ΔAF (S38). This is a processing for enhancing the flammability of the air-fuel mixture by correcting the target value A/F* in a decreasing manner.

On the other hand, if it is determined that the flaming delay is lower than the predetermined value (NO in S36), the target correction amount calculating process unit M14 adds the predetermined amount ΔΔ to the correction amount ΔAF (S40). This processing is a processing for decreasing the amount of fuel consumption by correcting the target value A/F* in an increasing manner.

If the processing of step S38 and the processing of step S40 are completed, the target correction amount calculating process unit M14 determines whether or not the correction amount ΔAF is smaller than a lower limit ΔAL (S42). It should be noted herein that the lower limit ΔAL is made equal to “0” in the present embodiment. This corresponds to the fact that the base value in the second mode is set to a value that makes it possible to maintain flammability even when the discharge time TD is minimized.

Then, if it is determined that the correction amount ΔAF is smaller than the lower limit ΔAL (YES in S42), the target correction amount calculating process unit M14 makes the correction amount ΔAF equal to the lower limit ΔAL (S44). Incidentally, if the processing of step S44 is completed or if the result of the determination in step S30 or S42 is negative, the target correction amount calculating process unit M14 temporarily ends this series of processing steps.

The operation of the present embodiment will now be described. When the second mode in which the target air-fuel ratio setting process unit M12 sets the target value A/F* of the air-fuel ratio to a value that is leaner than the theoretical air-fuel ratio is selected, the control signal generating process unit M10 generates and outputs the discharge waveform control signal Sc. In this case, the current I1 flowing through the primary-side coil 52 at the time of the performance of the operation of closing the ignition switching element 60 through the ignition signal Si is captured by the ECU 40 as the voltage drop Vi1 in the shunt resistor 61. In the ECU 40, the coil temperature TCO is detected based on the voltage drop Vi1, and the discharge time TD corresponding to the time of control of the discharge current by the discharge control unit 86 is set to a longest permissible value in accordance with the detected coil temperature TCO.

On the other hand, the target correction amount calculating process unit M14 determines whether or not the flammability of the air-fuel mixture in the combustion chamber 24 is equal to or lower than the predetermined flammability. If the flammability is higher than the predetermined flammability, the target correction amount calculating process unit M14 corrects the target value A/F* in a gradually increasing manner by the predetermined amount ΔΔ. It should be noted herein that the flammability is adapted not to become equal to or lower than the predetermined flammability when the amount of correction by the target correction amount calculating process unit M14 is equal to zero even in the case where the coil temperature TCO is high and the discharge time TD is set to the shortest time, in the present embodiment. Therefore, the discharge time TD is lengthened unless the coil temperature TCO is the highest. Thus, an increasing correction amount of the target value A/F* is calculated by the target correction amount calculating process unit M14, and the target value A/F* is hence made equal to a leaner value. Thus, the air-fuel ratio of the air-fuel mixture is controlled to as lean a value as possible. This leads to decreasing the amount of fuel consumption (the amount of energy consumption) as much as possible although the axial torque of the internal combustion engine 10 is set as a required value. Incidentally, if the discharge time TD is lengthened through the processing of step S22, the processing of making the target value A/F* equal to a leaner value through calculation of the increasing correction amount of the target value A/F* by the target correction amount calculating process unit M14 corresponds to a processing by an air-fuel ratio raising process unit.

Incidentally, the inventor has confirmed that although the lengthening of the discharge time TD leads to an increase in the amount of energy consumption, this amount of increase is smaller than the amount of decrease in energy consumption resulting from the action of making the air-fuel ratio lean.

According to the present embodiment described above, the following effects are obtained. (1) The discharge time TD is made longer when the coil temperature TCO is low than when the coil temperature TCO is high. Thus, the discharge time TD can be lengthened as much as possible while restraining the reliability of the ignition device 30 from degrading.

(2) The coil temperature TCO is estimated based on the gradient MI of the current I1 grasped from the voltage drop Vi1, and the terminal voltage Vb of the battery 39. Thus, in comparison with the case where the terminal voltage Vb is not used, the coil temperature TCO can be estimated with higher accuracy, and the discharge time TD can hence be set longer.

(3) The air-fuel ratio in the combustion chamber 24 is raised more when the discharge time TD is set long than when the discharge time TD is set short. Thus, the amount of fuel consumption can be favorably decreased.

Next, the second embodiment will be described with reference to the drawings, focusing on what is different from the first embodiment.

In the aforementioned first embodiment, the discharge time TD is calculated for each of the cylinders, based on the coil temperature TCO estimated for each of the cylinders. In contrast, according to the present embodiment, the discharge time TD is set for all the cylinders, based on the highest value of the coil temperatures TCO of the respective cylinders.

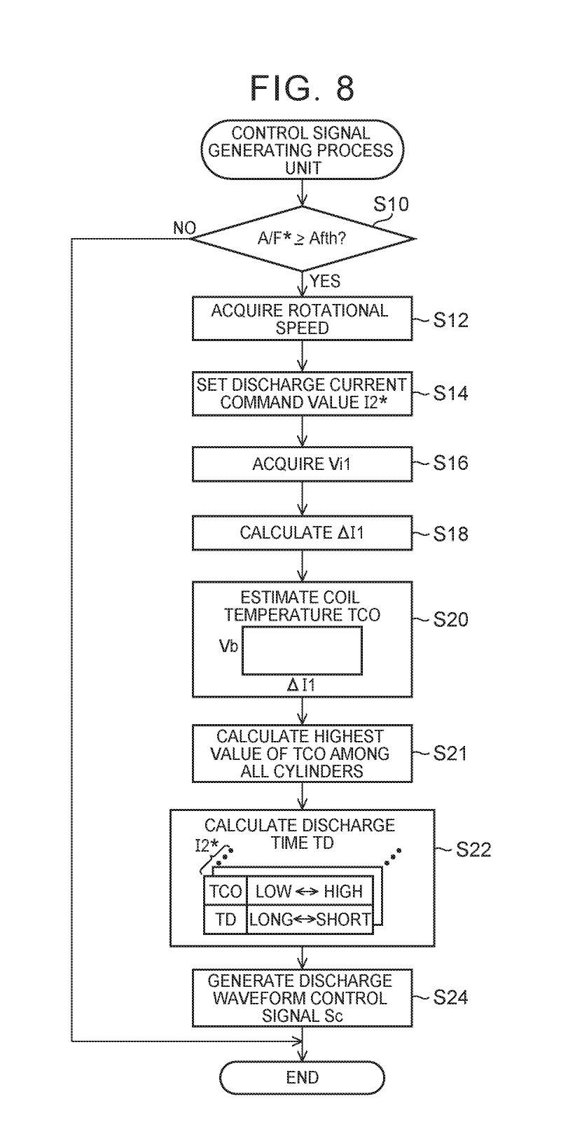

FIG. 8 shows a processing procedure of the control signal generating process unit M10 according to the present embodiment. This process is repeatedly executed, for example, on a predetermined cycle. Incidentally, in FIG. 8, processing steps corresponding to those of FIG. 6 are denoted by the same step numbers respectively, for the sake of convenience. It should be noted, however, that the process shown in FIG. 8 is a single logic for generating the discharge waveform control signal Sc for all the cylinders.

In this series of processing steps, upon estimating the coil temperature TCO in the processing of step S20, the control signal generating process unit M10 calculates the highest value of the coil temperatures TCO of all the cylinders (S21). This processing may be, for example, a processing of acquiring latest estimated values of the coil temperatures TCO of the respective cylinders and calculating the highest value among those estimated values.

Then, the control signal generating process unit M10 calculates the discharge time TD based on the highest value calculated in the processing of step S21 (S22). Therefore, as for at least one of the cylinders in which the coil temperature TCO is lower than the highest value, the discharge time TD is set to a time shorter than a longest time permitted for the ignition coil 50. By the way, in the present embodiment, the air-fuel ratio A/F detected by the air-fuel ratio sensor 44 is controlled to the target value A/F* in a feedback manner. It should be noted herein that the air-fuel ratio A/F detected by the air-fuel ratio sensor 44 is an average of the air-fuel ratios in the respective cylinders. In this manner, when the average of the air-fuel ratios is controlled to the target value A/F*, the target value A/F* is set such that the flammability of the cylinder with the lowest flammability becomes higher than the predetermined flammability, in the case where the flammability is made equal to or lower than the predetermined flammability and the target value A/F* is corrected toward a rich side. It should be noted herein that the cylinder with the lowest flammability is the cylinder with the shortest discharge time TD in the case where the discharge time TD is set for each of the cylinders, and hence coincides with the cylinder in which the coil temperature TCO assumes the highest value. Therefore, when the discharge time TD is set based on the coil temperature TCO of at least one of the cylinders in which the coil temperature TCO is lower than the highest value, the discharge time TD that exceeds the time required for the flammability to become higher than the predetermined flammability is set, so there is an apprehension of an unnecessary increase in the amount of electric power consumption.

Next, the third embodiment will be described with reference to the drawings, focusing on what is different from the first embodiment.

In the aforementioned first embodiment, the discharge control unit 86 performs the control of the discharge current as soon as the air-fuel ratio becomes lean. Besides, the air-fuel ratio is controlled to be as lean as possible when the discharge time TD is made long. In contrast, according to the present embodiment, the discharge control unit 86 performs the control of the discharge current as soon as the EGR rate becomes equal to or higher than a predetermined rate. Besides, the EGR rate is controlled to be as high as possible when the discharge time TD is made long.

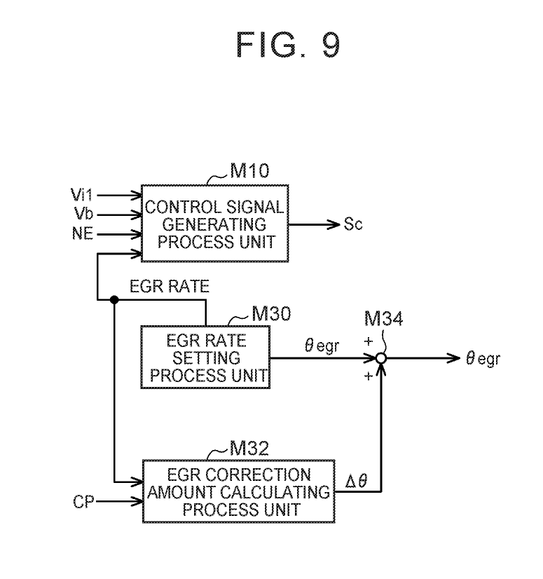

FIG. 9 shows a process of generating the discharge waveform control signal Sc and a process of controlling the EGR rate in particular, among the processes that are executed by the ECU 40. Incidentally, in FIG. 9, components corresponding to those shown in FIG. 5 are denoted by the same reference symbols respectively, for the sake of convenience.

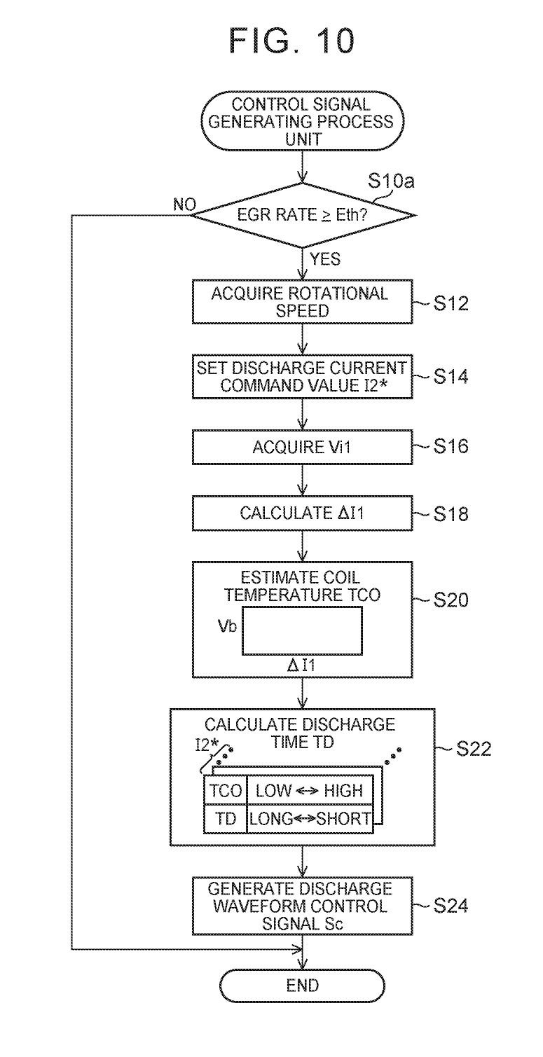

FIG. 10 shows a processing procedure of the control signal generating process unit M10 shown in FIG. 9. This process is repeatedly executed, for example, on a predetermined cycle. Incidentally, in FIG. 10, processing steps corresponding to those shown in FIG. 6 are denoted by the same step numbers respectively, for the sake of convenience.

As shown in FIG. 10, if it is determined that the EGR rate is equal to or higher than a predetermined rate Eth (YES in S10a), the control signal generating process unit M10 makes a transition to the processing of step S12. On the other hand, if it is determined that the EGR rate is lower than the predetermined rate Eth (NO in S10a), the control signal generating process unit M10 temporarily ends this series of processing steps. Incidentally, the determination that the EGR rate is equal to or higher than the predetermined rate Eth is a determination as to whether or not the flammability of the air-fuel mixture in the combustion chamber 24 is equal to or lower than a predetermined flammability when the discharge control unit 86 does not perform the control of the discharge current.

Returning to FIG. 9, an EGR rate setting process unit M30 sets an EGR rate in accordance with an operating state (a rotational speed, a load and the like) of the internal combustion engine 10, and sets an opening degree θegr of the recirculation valve 36 such that the set EGR rate is obtained. Incidentally, in the present embodiment, the EGR rate set by the EGR rate setting process unit M30 is set to a value that makes it possible to ensure flammability even by the discharge time TD that is set in the processing of step S22 in FIG. 10 when the temperature of the ignition coil 50 is equal to the highest assumable value.

If the EGR rate set by the EGR rate setting process unit M30 is equal to or higher than the predetermined rate Eth, an EGR correction amount calculating process unit M32 calculates a correction amount Δθ for correcting the opening degree θegr, based on the in-cylinder pressure CP detected by the in-cylinder pressure sensor 38. A correction process unit M34 corrects the opening degree θegr by adding the correction amount Δθ to the opening degree θegr set by the EGR rate setting process unit M30. The ECU 40 performs electronic control such that the opening degree of the recirculation valve 36 becomes equal to the opening degree θegr.

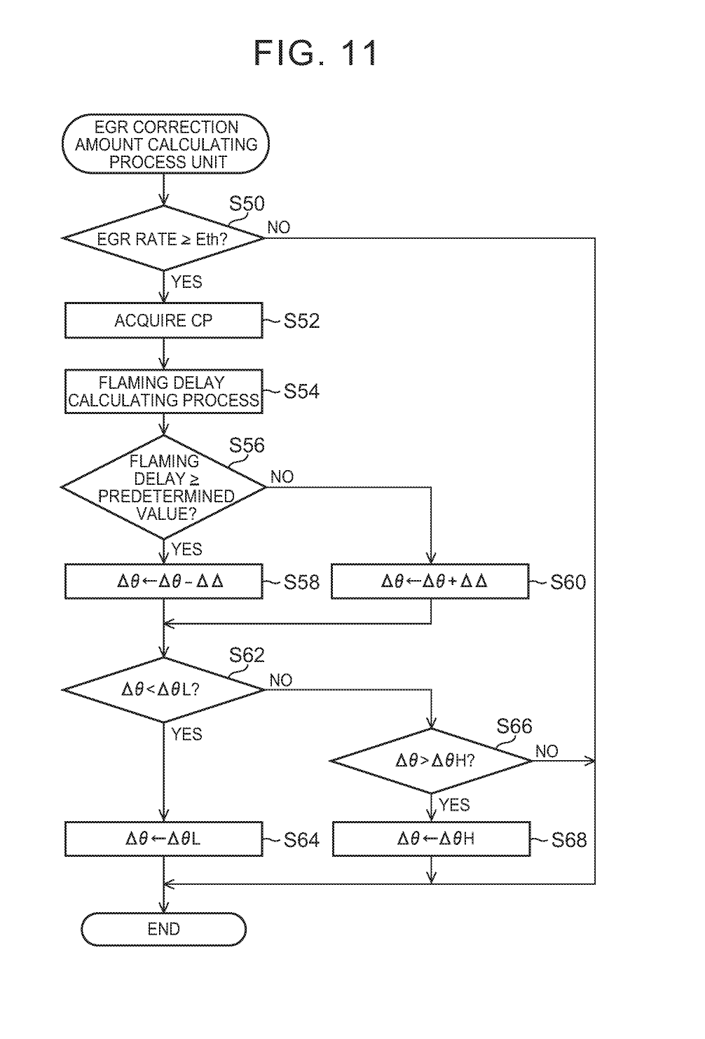

FIG. 11 shows a processing procedure of the EGR rate setting process unit M30. This process is repeatedly executed, for example, on a predetermined cycle. In this series of processing steps, the EGR rate setting process unit M30 first determines whether or not the EGR rate is equal to or higher than the predetermined rate Eth (S50). This processing is designed to determine whether or not the discharge control unit 86 performs the control of the discharge current. Then, if it is determined that the EGR rate is equal to or higher than the predetermined rate Eth (YES in S50), the EGR rate setting process unit M30 executes steps S52 to S56 that are identical to the processing steps S32 to S36 in FIG. 7.

Then, if it is determined that the flaming delay is equal to or larger than a predetermined value (YES in S56), the EGR rate setting process unit M30 corrects the correction amount Δθ in a decreasing manner by the predetermined amount ΔΔ (S58). This processing is a processing of decreasing the EGR rate. On the other hand, if it is determined that the flaming delay is smaller than the predetermined value (NO in S56), the EGR rate setting process unit M30 corrects the correction amount Δθ in an increasing manner by the predetermined amount ΔΔ (S60).

Upon updating the correction amount Δθ, the EGR rate setting process unit M30 determines whether or not the updated correction amount Δθ is smaller than a lower limit ΔθL (S62). Then, if it is determined that the updated correction amount Δθ is smaller than the lower limit ΔθL (YES in S62), the EGR rate setting process unit M30 makes the correction amount Δθ equal to the lower limit ΔθL (S64). It should be noted herein that the lower limit ΔθL is made equal to zero in the present embodiment. This takes into account the fact that the EGR rate set by the EGR rate setting process unit M30 is adapted to such a value that the flammability does not become equal to or lower than the predetermined flammability even in the case where the discharge time TD is made equal to the shortest value. In other words, this takes into account the fact that the opening degree θegr set by the EGR rate setting process unit M30 is adapted to such a value that the flammability does not become equal to or lower than the predetermined flammability even in the case where the discharge time TD is made equal to the shortest value.

On the other hand, if it is determined that the updated correction amount Δθ is larger than the lower limit ΔθL (NO in S62), the EGR rate setting process unit M30 determines whether or not the correction amount Δθ is larger than an upper limit ΔθH (S66). Then, if it is determined that the correction amount Δθ is larger than the upper limit ΔθH (YES in S66), the EGR rate setting process unit M30 sets the correction amount Δθ to the upper limit ΔθH (S68). It should be noted herein that the upper limit ΔθH may be set based on, for example, a value that makes flaming itself impossible when the opening degree θegr is further increased. It is desirable to variably set the upper limit ΔθH based on the EGR rate, the amount of intake air or the like.

Incidentally, if the processing of step S64 or the processing of step S68 is completed or if the result of the determination in step S50 or step S66 is negative, the EGR rate setting process unit M30 temporarily ends this series of processing steps.

The operation of the present embodiment will now be described. When the EGR rate setting process unit M30 sets the EGR rate equal to or higher than the predetermined rate Eth, the control signal generating process unit M10 generates and outputs the discharge waveform control signal Sc. In this case, the current I1 flowing through the primary-side coil 52 at the time of the performance of the operation of closing the ignition switching element 60 through the ignition signal Si is captured by the ECU 40 as the voltage drop Vi1 in the shunt resistor 61. In the ECU 40, the coil temperature TCO is detected based on the voltage drop Vi1, and the discharge time TD corresponding to the time of control of the discharge current by the discharge control unit 86 is set to a longest permissible value in accordance with the detected coil temperature TCO.

On the other hand, the EGR correction amount calculating process unit M32 determines whether or not the flammability of the air-fuel mixture in the combustion chamber 24 is equal to or lower than the predetermined flammability. If the flammability is higher than the predetermined flammability, the EGR correction amount calculating process unit M32 corrects the opening degree θegr of the recirculation valve 36 in a gradually increasing manner by the predetermined amount ΔΔ. It should be noted herein that the flammability is adapted not to become equal to or lower than the predetermined flammability when the amount Δθ of correction by the EGR correction amount calculating process unit M32 is equal to zero even in the case where the coil temperature TCO is high and the discharge time TD is set to the shortest value in the present embodiment. Therefore, when the coil temperature TCO is not equal to the highest temperature, the discharge time TD is lengthened. Thus, the EGR correction amount calculating process unit M32 calculates an increasing correction amount of the opening degree θegr, and hence increases the EGR rate. This leads to decreasing the amount of fuel consumption (the amount of energy consumption) as much as possible although the axial torque of the internal combustion engine 10 is set as a required value. Incidentally, when the discharge time TD is lengthened through the processing of step S22, the processing of increasing the EGR rate by calculating the increasing correction amount of the opening degree θegr by the EGR correction amount calculating process unit M32 corresponds to the process by a recirculation increasing process unit.

Incidentally, the inventor has confirmed that although the lengthening of the discharge time TD leads to an increase in the amount of energy consumption, this amount of increase is smaller than the amount of decrease in energy consumption resulting from the action of increasing the EGR rate.

Incidentally, at least one of the respective matters of the aforementioned first to third embodiments may be altered as follows. Although the following has a part exemplifying a corresponding relationship to the matters in the aforementioned embodiments using reference symbols and the like, the exemplified corresponding relationship is not intended to limit the aforementioned matters.

The current flowing through the ignition coil may be altered as follows. In the aforementioned embodiment, the voltage drop Vi1 in the shunt resistor 61 is used as the current for detecting the gradient ΔI1, but the present disclosure is not limited thereto. For example, a current transformer may be provided between the primary-side coil 52 and the ignition switching element 60, and the current detected by the current transformer may be used.

Besides, an acquisition process unit (S20) may be altered as follows. For example, if the amount of fluctuations in the voltage of the electric power supply that applies a voltage to the ignition coil 50 is negligible, a temperature of the ignition coil 50 that is estimated from only the gradient of a current flowing through the ignition coil 50 may be acquired. This is applicable to, for example, a case where the step-up voltage of a step-up chopper circuit that performs a step-up operation every time the ignition coil 50 is energized is used as an electric power supply voltage, and the like.

Incidentally, if the amount of fluctuations in the voltage of the electric power supply that applies a voltage to the ignition coil 50 is negligible as described above, the gradient itself of the current flowing through the ignition coil 50 may be acquired as the temperature of the ignition coil 50. In this case, for example, the discharge time TD may be lengthened as the gradient increases, in the processing of step S22 in FIG. 6.

In each of the aforementioned embodiments, the coil temperature TCO that is estimated based on the terminal voltage Vb of the battery 39 and the gradient ΔI1 is acquired, but the present disclosure is not limited thereto. For example, the temperature of the in-cylinder injection valve 26 that directly injects fuel to the combustion chamber 24 may be acquired as the temperature of the ignition coil 50. It should be noted herein that in the case where the in-cylinder injection valve 26 is equipped with a coil, the temperature of the in-cylinder injection valve 26 may be estimated based on the gradient of the current at the time of energization of the coil.

Nonetheless, the present disclosure is not limited to the acquisition of an estimated value based on the gradient of the current flowing through the coil. For example, a temperature detection device such as a thermistor or the like may be provided inside the ignition device 30, and a detection value of the temperature detection device may be acquired.

In each of the aforementioned embodiments, the coil temperatures TCO of all the cylinders are acquired, but the present disclosure is not limited thereto. Only the coil temperature TCO of a specific one of the cylinders may be acquired, and the discharge waveform control signals Sc of all the cylinders may be generated based on the acquired coil temperature TCO.

Besides, a lengthening process unit (S22) may be altered as follows. In each of the aforementioned embodiments, the two-dimensional map that determines how the coil temperature TCO and the discharge current command value I2* are related to the discharge time TD is provided, and the discharge time TD is calculated using the two-dimensional map, but the present disclosure is not limited thereto. For example, a one-dimensional map that determines a relationship between the coil temperature TCO and the discharge time TD may be provided, and the discharge time TD may be calculated based on the one-dimensional map.

Besides, the map is not absolutely required to be provided. For example, the discharge time TD may be calculated using a relational expression that determines a relationship between the coil temperature TCO and the discharge time TD, or a relational expression that determines how the coil temperature TCO and the discharge current command value I2* are related to the discharge time TD.

The discharge time TD is not absolutely required to be continuously lengthened as the coil temperature TCO falls. For example, the discharge time TD may be gradually lengthened in several stages. Furthermore, the discharge time TD may be set to one of a pair of values that are different from each other, depending on whether or not the coil temperature TCO is equal to or higher than a predetermined temperature.

Besides, a flammability determining process unit (S36, S56) may be altered as follows. In each of the aforementioned embodiments, it is determined, based on the in-cylinder pressures CP detected by the in-cylinder pressure sensors 38 in the respective cylinders, whether or not the flammability is equal to or lower than the predetermined flammability, but the present disclosure is not limited thereto. For example, the in-cylinder pressure sensor may be provided in only a representative one of the cylinders, and it may be determined, based on the in-cylinder pressure CP detected by that in-cylinder pressure sensor, whether or not the flammability is equal to or lower than the predetermined flammability.

The determination as to whether or not the flammability is equal to or lower than the predetermined flammability based on the in-cylinder pressure CP detected by the in-cylinder pressure sensor 38 is not limited to the determination as to whether or not the flaming delay is equal to or larger than the predetermined value. For example, it may be determined that the flammability is equal to or lower than the predetermined flammability when the amount of fluctuations in the axial torque, which is calculated based on the in-cylinder pressure CP, is equal to or larger than a predetermined value.

It is not indispensable to determine, based on the in-cylinder pressure CP detected by the in-cylinder pressure sensor 38, whether or not the flaming delay is equal to or larger than the predetermined value. For example, the presence or absence of misfire may be detected based on the amount of fluctuations in the rotational speed NE detected by the crank angle sensor 42, and it may be determined that the flammability is equal to or lower than the predetermined flammability when the frequency of the occurrence of misfire is equal to or higher than a predetermined frequency.

Besides, the raising process unit (S40) may be altered as follows. In the process of FIG. 7, there may be provided a dead zone in which the correction amount ΔAF is neither increased nor decreased, instead of decreasing the correction amount ΔAF when the flaming delay is equal to or larger than the predetermined value and increasing the correction amount ΔAF when the flaming delay is smaller than the predetermined value. That is, the correction amount ΔAF may be increased when the flaming delay is smaller than the predetermined value, and the correction amount ΔAF may be decreased when the flaming delay is equal to or larger than a prescribed value that is larger than the predetermined value.

The target value A/F* of the air-fuel ratio is not absolutely required to be corrected. For example, the air-fuel ratio A/F detected by the air-fuel ratio sensor 44 may be stopped from being used as a feedback controlled variable. The air-fuel ratio may be corrected in a raising manner by using an open-loop manipulated variable in obtaining the target value A/F* as an injection amount base value, and correcting the injection amount base value in a gradually decreasing manner.

The present disclosure is not absolutely required to postulate that a value that makes it possible to ensure flammability by the discharge time TD that is set at the highest assumable value of the temperature of the ignition coil 50 is used as the base value of the target value A/F* in the second mode (the value set by the target air-fuel ratio setting process unit M12). For example, the present disclosure may postulate the use of a value that makes it possible to ensure flammability by the discharge time TD that is set when the temperature of the ignition coil 50 is low. In this case as well, the flammability can be restrained from falling, by correcting the target value A/F* in a decreasing manner when the discharge time TD is insufficient in maintaining high flammability. Then, when the discharge time TD is lengthened afterward, the target value A/F* is gradually raised through the processing of step S40 in FIG. 7.

Incidentally, even in the case where it is premised that a value that makes it possible to ensure flammability by the discharge time TD that is set at the highest assumable value of the temperature of the ignition coil 50 is used as the base value of the target value A/F* in the second mode, the lower limit of step S42 in FIG. 7 may be set to a value that is smaller than zero. It should be noted, however, that the predetermined value Afth in the processing of step S30 is also changed, and the processing steps S32 to S44 are continued even when the correction amount ΔAF becomes smaller than zero in this case.

Besides, the increasing process unit (S60) may be altered as follows. In the process of FIG. 11, there may be provided a dead zone in which the correction amount Δθ is neither increased nor decreased instead of decreasing the correction amount Δθ when the flaming delay is equal to or larger than the predetermined value, and increasing the correction amount Δθ when the flaming delay is smaller than the predetermined value. That is, the correction amount Δθ may be increased when the flaming delay is smaller than the predetermined value, and the correction amount Δθ may be decreased when the flaming delay is equal to or larger than the prescribed value that is larger than the predetermined value.

The processing of gradually raising the EGR rate is not limited to the processing of correcting the opening degree θegr of the recirculation valve 36 in a gradually increasing manner. For example, the opening degree θegr in the case where the EGR rate or the EGR amount is increased by a prescribed value may be calculated based on an inverse model of a model for estimating the EGR rate or the EGR amount, and the recirculation valve 36 may be operated such that the calculated opening degree θegr is obtained.

Besides, the air-fuel ratio raising process unit (FIG. 7) may be altered as follows. The air-fuel ratio is raised not only when it is detected that the flammability has not fallen. For example, a processing of setting the target value A/F* to a value that increases as the discharge time TD lengthens, with the discharge time TD used as an input, may be executed. This is a processing of controlling, in an open-loop manner, the air-fuel ratio to as lean a value as possible while maintaining flammability.

Besides, the target air-fuel ratio setting process unit M12 may be altered as follows. The target value in the first mode is not absolutely required to be the theoretical air-fuel ratio. Besides, the first mode itself may be excluded. In this case, it is appropriate that the discharge control unit 86 never fail to perform the control of the discharge current at the ignition timing.

The target value is not absolutely required to be set to one of the two values in the first mode and the second mode. For example, the target value A/F* may be variably set based on the discharge time TD in the second mode. In this case, the target air-fuel ratio setting process unit M12 is an open-loop controller that controls the air-fuel ratio to as lean a value as possible while maintaining flammability. The process shown in FIG. 7 is a closed-loop controller that manipulates the air-fuel ratio using the flammability as a controlled variable.

Besides, the recirculation increasing process unit (FIG. 11) may be altered as follows. The EGR rate is raised not only when it is detected that the flammability has not fallen. For example, a processing of setting the EGR rate to a value that increases as the discharge time TD lengthens, using the discharge time TD as an input, may be executed. This is a processing of controlling, in an open-loop manner, the EGR rate to as large a value as possible while maintaining flammability.

Besides, the EGR rate setting process unit M30 may be altered as follows. The discharge control unit 86 may never fail to perform the control of the discharge current at the ignition timing, and the EGR rate may normally be set to such a value that the flammability is equal to or lower than the predetermined flammability when the discharge control unit 86 does not perform the control of the discharge current.

The opening degree θegr is not absolutely required to be set in accordance with the rotational speed or load of the internal combustion engine 10. For example, the opening degree θegr may be variably set based on the discharge time TD. In this case, the EGR rate setting process unit M30 is an open-loop controller that controls the EGR rate to as large a value as possible while maintaining flammability. The process shown in FIG. 11 is a closed-loop controller that manipulates the EGR rate using the flammability as a controlled variable.

Besides, the control of the air-fuel ratio and the EGR rate may be altered as follows. Both the processing of raising the air-fuel ratio and the processing of increasing the EGR rate may be executed unless the flammability becomes equal to or lower than the predetermined flammability.

In each of the aforementioned embodiments, the average of all the cylinders is controlled, but the present disclosure is not limited thereto. For example, the air-fuel ratio of each of the cylinders may be controlled. In this case, it is especially effective to set the discharge time TD of each of the cylinders based on the coil temperature TCO of that cylinder.

Besides, the discharge control unit may be altered as follows. The detection value of the discharge current value is not absolutely required to be controlled to the discharge current command value I2* in a feedback manner, but may be controlled to the discharge current command value I2* in an open-loop manner. This can be realized by variably setting the time ratio of the operation of opening-closing the control switching element 80 in accordance with the discharge current command value I2*. It should be noted, however, that the time ratio is desirably set in view of the load of the internal combustion engine 10 in this case.

Besides, the discharge control circuit (70, 80, 82) may be altered as follows. It is not indispensable that the first electric power supply be the battery 39, and that the second electric power supply be the battery 39 and the step-up circuit 70. For example, there may be provided a circuit that can connect the battery 39 and the primary-side coil 52 to each other such that a voltage that is opposite in polarity to the voltage at the time of the operation of closing the ignition switching element 60 is applied to the primary-side coil 52. In this case, both the first electric power supply and the second electric power supply are the battery 39.

The primary-side coil 52 is not absolutely required to be energized in order to control the discharge current of the ignition plug 28. For example, a third coil that is magnetically coupled to the secondary-side coil 54 may be energized separately from the primary-side coil 52. In this case, the third coil is insulated at both ends thereof while the operation of closing the ignition switching element 60 is performed. After the operation of opening the ignition switching element 60 is performed, the third coil is energized in the same manner as the primary-side coil 52 is energized in each of the aforementioned embodiments.

The nonoccurrence of discharge of the ignition plug 28 is not indispensable when the ignition switching element 60 is closed. For example, discharge may be caused from one of electrodes of the ignition plug 28 to the other electrode thereof by closing the ignition switching element 60, and discharge may occur from the aforementioned other electrode to the aforementioned one of the electrodes due to a back electromotive force generated in the secondary-side coil 54, through the operation of opening the ignition switching element 60. In this case as well, it is effective to provide a discharge control circuit that maintains a discharge current after the start of discharge from the other electrode to the one of the electrodes.

Still further, the internal combustion engine may also be altered as follows. The internal combustion engine is not absolutely required to apply motive power to the driving wheels of the vehicle. For example, the internal combustion engine may be mounted in a series hybrid vehicle. Furthermore, the internal combustion engine may be mounted in a so-called plug-in hybrid vehicle that can capture electric power from outside the vehicle. In this case as well, the effect of decreasing the amount of fuel consumption by making the air-fuel ratio lean or increasing the EGR rate is considered to exceed the effect of increasing the amount of electric energy consumption by lengthening he discharge time TD.

What is claimed is:

1. A control apparatus for an internal combustion engine, the control apparatus comprising:
an ignition device that includes an ignition plug that is provided in a combustion chamber of the internal combustion engine, and an ignition coil that is connected to the ignition plug; and
an electronic control unit that is configured to:
(i) acquire a temperature of the ignition device, and
(ii) make a discharge time of the ignition plug longer when the temperature acquired by the electronic control unit is low than when the temperature is high.

2. The control apparatus for the internal combustion engine according to claim 1, wherein
the electronic control unit is configured to:
(i) acquire a gradient of a current flowing through the ignition coil, as the temperature, and
(ii) execute a process of making the discharge time of the ignition plug longer when the gradient is large than when the gradient is small, as a process of making the discharge time of the ignition plug longer when the temperature acquired by the electronic control unit is low than when the temperature is high.

3. The control apparatus for the internal combustion engine according to claim 2, wherein
the electronic control unit is configured to:
(i) acquire a voltage applied to the ignition coil in addition to the gradient of the current flowing through the ignition coil,
(ii) make the discharge time of the ignition plug longer when the gradient is large than when the gradient is small, when an applied voltage remains unchanged, and
(iii) shorten the discharge time of the ignition plug as the applied voltage rises, when the gradient remains unchanged.

4. The control apparatus for the internal combustion engine according to claim 2, wherein
the internal combustion engine is a multi-cylinder internal combustion engine, and
the electronic control unit is configured to:
(i) acquire gradients of currents flowing through ignition coils corresponding to ignition plugs of respective cylinders, as the temperature, and
(ii) set the discharge time in accordance with a smallest one of acquired gradients in the respective cylinders.

5. The control apparatus for the internal combustion engine according to claim 1, wherein
the electronic control unit is configured to make an air-fuel ratio of an air-fuel mixture in the combustion chamber larger when the discharge time is set long than when the discharge time is set short.

6. The control apparatus for the internal combustion engine according to claim 5, wherein
the electronic control unit is configured to:
(i) determine whether or not a flammability of the air-fuel mixture in the combustion chamber is equal to or lower than a predetermined value, and
(ii) gradually raise the air-fuel ratio when the electronic control unit does not determine that the flammability is equal to or lower than the predetermined value.

7. The control apparatus for the internal combustion engine according to claim 1, wherein
the internal combustion engine includes a recirculation passage and a recirculation valve,
the recirculation passage is configured to cause exhaust gas discharged to an exhaust passage to flow into an intake passage,
the recirculation valve is configured to adjust a flow cross-sectional area of the recirculation passage, and
the electronic control unit is configured to make a ratio of an amount of exhaust gas flowing into the combustion chamber via the recirculation passage to an amount of an air-fuel mixture in the combustion chamber larger when the discharge time is set long than when the discharge time is set short.

8. The control apparatus for the internal combustion engine according to claim 7, wherein
the electronic control unit is configured to:
(i) determine whether or not a flammability of the air-fuel mixture in the combustion chamber of the internal combustion engine is equal to or lower than a predetermined value, and
(ii) gradually increase the ratio when the electronic control unite does not determine that the flammability is equal to or lower than the predetermined value.

9. The control apparatus for the internal combustion engine according to claim 1, wherein
the ignition device includes an ignition switching element and a control switching element,
the ignition switching element is configured to open-close a first loop circuit that includes a primary-side coil of the ignition coil and a first electric power supply,
the control switching element is configured to open-close a second loop circuit that includes a second electric power supply and the primary-side coil, and
the electronic control unit is configured to:
(i) cause the ignition plug to discharge through an electromotive force that is generated in a secondary-side coil of the ignition coil by changing over the ignition switching element from a closed state to an open state,
(ii) after discharging the ignition plug, control a discharge current of the ignition plug by performing an operation of opening-closing the control switching element, and
(iii) set the discharge time by setting a timing for finishing control of the discharge current of the ignition plug, a polarity of a first voltage and a polarity of a second voltage being opposite to each other, the first voltage being applied to the primary-side coil by the first electric power supply at a time when the first loop circuit is a closed loop. and the second voltage being applied to the primary-side coil by the second electric power supply at a time when the second loop circuit is a closed loop.
